(19) United States
(12) Patent Application Publication
(10) Pub. No.: US 2006/0016071 A1
(43) Pub. Date: Jan. 26, 2006

(54) Method for attaching an IC socket connector to a circuit board

(76) Inventor: Huang-Chou Huang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/898,191

(22) Filed: Jul. 26, 2004

(51) Int. Cl. H01K 3/10

(52) U.S. Cl. 29/852

(57) ABSTRACT

A method for attaching an IC socket connector to a circuit board has acts of fabricating IC socket connectors, installing the IC socket connectors in an IC socket, preparing the IC socket connectors for attachment to a circuit board and attaching the IC socket connector to the circuit board. The IC socket connectors are U-shaped, are punched from a metal sheet, have a closed bottom and are electroplated with a protective nickel coating. After installing the IC socket connectors in an IC socket, a recess is formed in the closed bottom of each IC socket connector in any shape. Solder balls are attached respectively to the recesses in the bottoms of the IC socket connectors. The IC socket connectors are attached to the circuit board by melting the solder ball.

### BACKGROUND OF THE INVENTION

1. Field of the Invention

The present invention relates to a method for attaching an IC socket connector to a circuit board.

2. Description of the Prior Art

With reference to FIGS. 5 and 6, a conventional method of attaching an IC socket connector (10) to a circuit board in accordance with the prior art comprises fabricating the IC socket connector (10), installing the IC socket connector (10) in an IC socket (20), attaching a solder ball to the IC socket connector (10) and attaching the IC socket connector (10) to a circuit board.

Fabricating the IC socket connector (10) comprises punching the IC socket connector (10) from a metal sheet and electroplating the IC socket connector (10) with a protective nickel coating. Each IC socket connector is U-shaped, has an open top, a closed bottom and an IC chip lead clamp and is mounted in an IC socket (20).

The solder ball is attached to the protective nickel coating on the bottom of the IC socket connector (10).

Attaching the IC socket connector (10) to the circuit board comprises coating the solder ball with soldering flux, placing the socket (20) on the circuit board, melting the solder ball and the protective nickel coating on the bottom of the IC socket connector (10), cooling the solder ball and the protective nickel coating and integrating the solder ball and the protective nickel coating. Melting and cooling the solder ball and the protective nickel coating on the bottom of the IC socket connector (10) and integrating the solder ball and the protective nickel coating requires an amount of time called eutectic time. The eutectic time is usually 40-120 seconds, and a significant amount of the time is required to melt the protective nickel coating. Because the solder ball is attached to the protective nickel coating rather than directly to the IC socket connector (10) and the solder ball melts at a significantly lower temperature than the protective nickel coating, the solder ball melts and tends to flow away before the protective nickel coating melts. The early melting and flowing of the solder ball will often cause the IC socket connector (10) and the circuit board to connect improperly and possibly not at all.

To overcome the shortcomings, the present invention provides a method for attaching an IC socket connector to a circuit board to mitigate or obviate the aforementioned problems.

### SUMMARY OF THE INVENTION

The main objective of the present invention is to provide a method for attaching an IC socket connector to a circuit board to keep a melted solder ball from flowing and to reduce the eutectic time.

A method of attaching an IC socket connector to a circuit board in accordance with the present invention comprises fabricating the IC socket connector, installing the IC socket connector in an IC socket, preparing the IC socket connector for attachment and attaching the IC socket connector to a circuit board. The IC socket connector is U-shaped, has an open top, a closed bottom, an IC chip lead clamp and a protective nickel coating and is installed in an IC socket.

Preparing the IC socket connector for attachment comprises forming a recess in the bottom of the IC socket connector and attaching a solder ball to the recess in the bottom of the IC socket connector. The recess must be completely through the protective nickel coating, may be formed by photoetching, or mechanical or chemical techniques and may be any shape. The solder ball is attached to the recess on the bottom of the IC socket connector.

Attaching the IC socket connector to a circuit board comprises coating the solder ball with soldering flux, placing the IC socket on the circuit board, melting the solder ball in the recess on the closed bottom of the IC socket connector to get molten solder, cooling the molten solder. Surface tension of the molten solder keeps the solder form flowing away from the recess. Cooling the molten solder causes the solder to solidify and attach the IC socket connector to the circuit board.

Other objectives, advantages and novel features of the invention will become more apparent from the following detailed description when taken in conjunction with the accompanying drawings.

### BRIEF DESCRIPTION OF THE DRAWINGS

FIG. 1 is a side view in a partial section of an IC socket connector and an IC socket in accordance with the present invention with a solder ball between the IC socket connector and a circuit board;

FIG. 2 is a block diagram of a method for attaching an IC socket connector to a circuit board in accordance with the present invention;

FIG. 3 is a bottom view of an alternative embodiment of the IC socket connector in FIG. 1 in accordance with the present invention;

FIG. 4 is a bottom view of another embodiment of the IC socket connector in FIG. 1 in accordance with the present invention;

FIG. 5 is an exploded perspective view of an IC socket connector and an IC socket in accordance with the prior art; and

FIG. 6 is a block diagram of a conventional method for attaching an IC socket connector to a circuit board in accordance with the prior art.

### DETAILED DESCRIPTION OF THE PREFERRED EMBODIMENTS

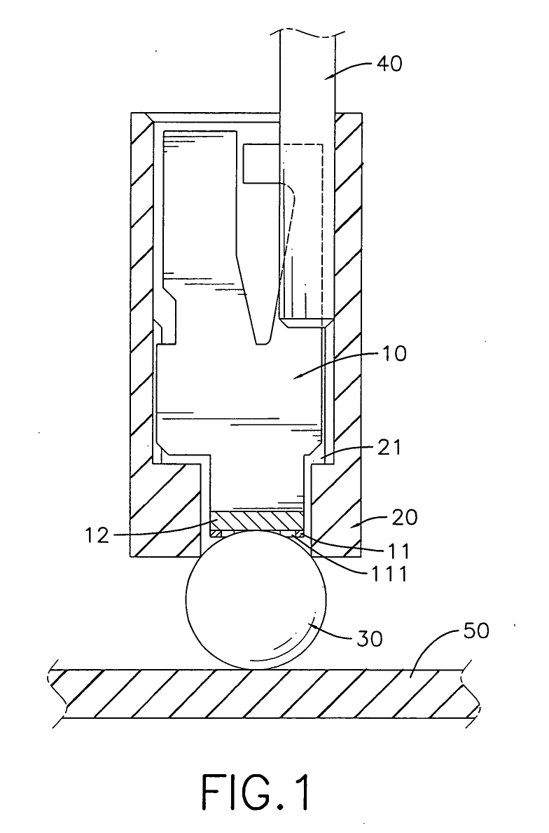

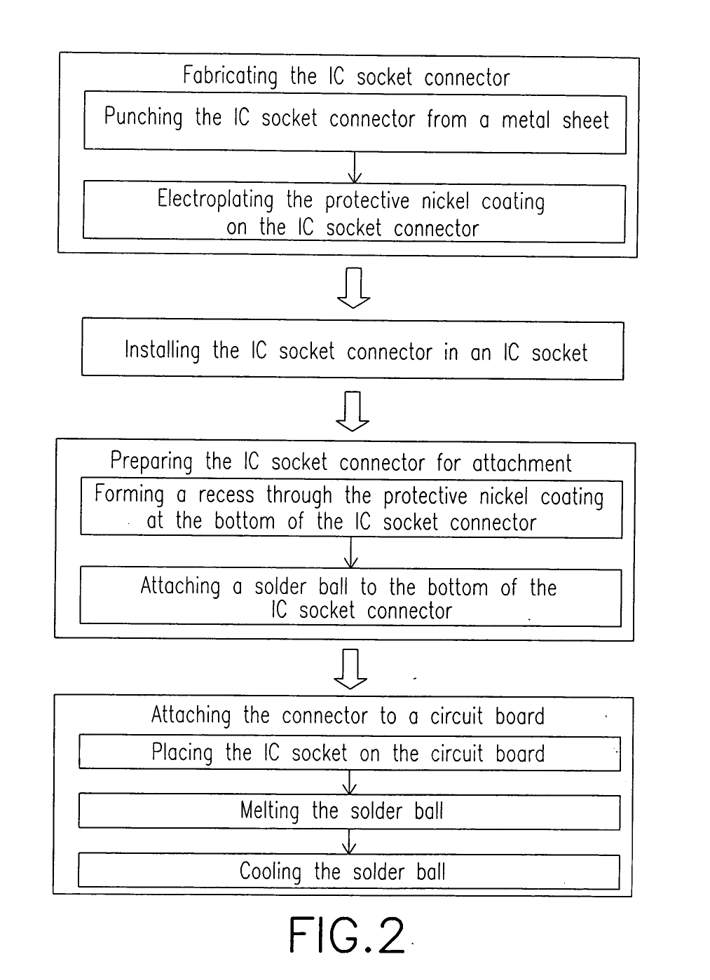

With reference to FIGS. 1 and 2, the method to attach an IC socket connector (10) to a circuit board (50) comprises fabricating IC socket connectors (10), installing the IC socket connectors (10) in an IC socket (20), preparing the IC socket connectors (10) for attachment to a circuit board (50) and attaching the IC socket connector (10) to the circuit board (50).

The IC socket connectors (10) are fabricated by punching U-shaped IC socket connectors (10) from a metal sheet and electroplating a nickel protective coating on the IC socket connectors (10). Each IC socket connector (10) is U-shaped and has a protective nickel coating (11), an open top, a closed bottom (12) and an IC chip lead clamp. The IC chip lead clamp is formed at the open top of each IC socket connector (10) and clamps a corresponding IC chip lead (40) pressed into the top of the IC socket connector (10).

The IC socket connectors (10) are installed in an IC socket (20) that has multiple connector holes (21). Each connector hole (21) has an open top, an inner surface and an open bottom. The IC socket connectors (10) are inserted respectively into the connector holes (21) through the open tops. The inner surface of each connector hole (21) aligns and holds an IC socket connector (10). The closed bottom (12) of each IC socket connector (10) is exposed through the open bottom of the connector hole (21).

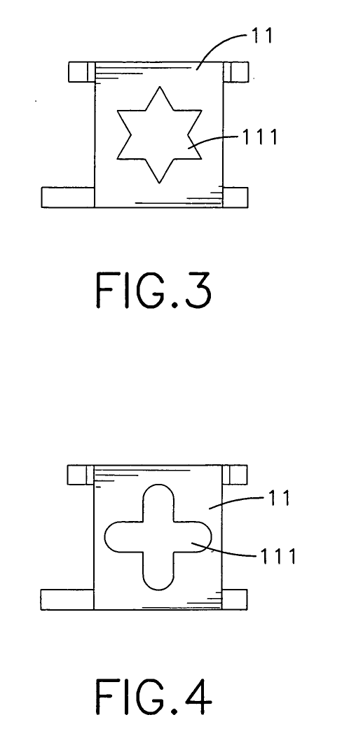

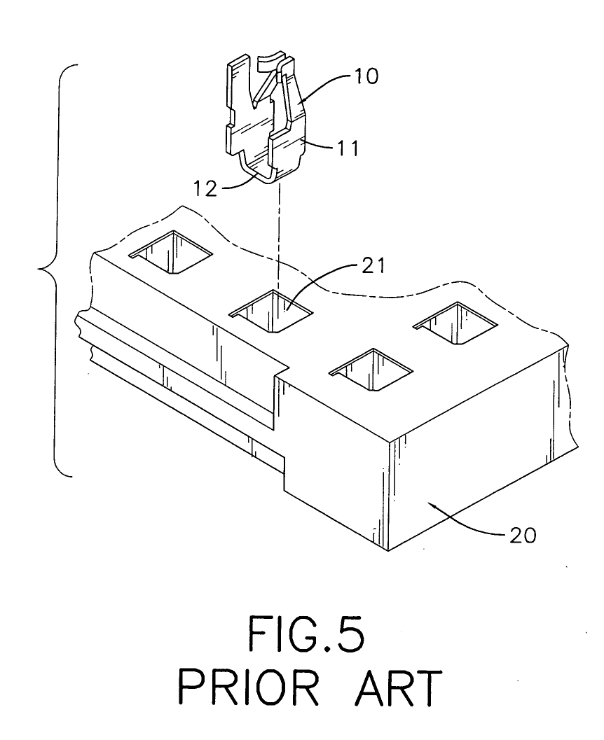

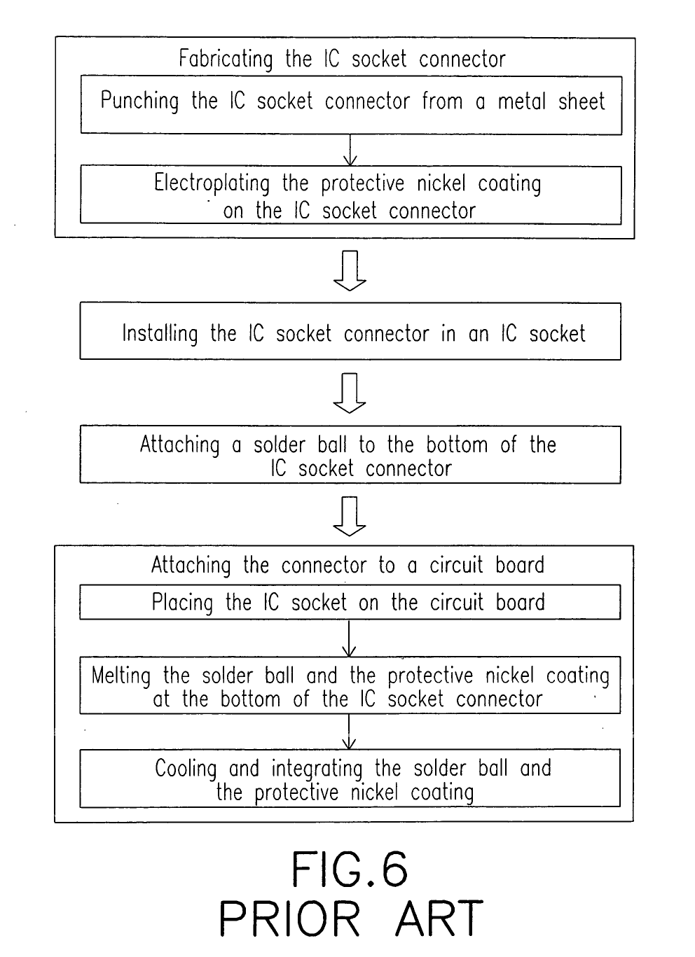

Preparing the IC socket connectors (10) for attachment to a circuit board (50) comprises forming a recess (111) in the closed bottom (12) of the IC socket connector (10) and attaching a solder ball (30) to the recess (111) in the closed bottom (12) of the IC socket connector (10). The recess (12) must be completely through the protective nickel coating (11), may be formed by photoetching or mechanical or chemical techniques and may be any shape. With further reference to FIGS. 3 and 4, one embodiment of the IC socket connector (10) in accordance with the present invention has a star-shaped recess (111) formed in the closed bottom (12), and another embodiment of the IC socket connector (10) in accordance with the present invention has a cross-shaped recess (111) formed in the closed bottom (12).

Attaching the IC socket connector (10) to a circuit board (50) comprises coating the solder ball (30) with soldering flux, placing the IC socket (20) on the circuit board (50), melting the solder ball (30) in the recess (111) on the closed bottom (12) of the IC socket connector (10) to get molten solder, cooling the molten solder to form a joint between the IC socket connector (10) and the circuit board (50). Surface tension of the molten solder keeps the solder form flowing away from the recess (111). Cooling the molten solder causes the solder to solidify and attach the IC socket connector (10) to the circuit board (50).

The present invention has numerous advantages. Because the solder ball (30) is attached directly to the recess (111) in the closed bottom (12) of the IC socket connector (10), the molten solder will not flow when the solder ball (30) is melted. Time required to melt the solder ball (30) and to cool the molten solder to attach the solder to the closed bottom (12) of the IC socket connector (10) and the circuit board (50) is eutectic time. Because the solder ball (30) is not attached to the nickel protective coating (11), the nickel protective coating (11) does not have to be melted, cooled and integrated with the melted solder ball (30), and the eutectic time will be less than 30 seconds.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A method for attaching an IC socket connector to a circuit board that is mounted in an IC socket with multiple connector holes having an open top, an inner surface and an open bottom, the method comprising acts of:
fabricating IC socket connectors by:
punching U-shaped IC socket connectors from a metal sheet wherein each IC socket connector has an open top, a closed bottom and an IC chip lead clamp formed at the open top of each IC socket connector to clamp a corresponding IC ship lead pressed into to the top of the IC socket connector;
electroplating a protective nickel coating on the IC socket connectors;
installing the IC socket connectors respectively in the connector holes in the IC socket so the closed bottom of each IC socket connector is exposed through the open bottom of the connector hole;
preparing the IC socket connectors for attachment to a circuit board comprises
forming a recess in the closed bottom of the IC socket connector wherein the recess is formed completely through the protective nickel coating; and
attaching a solder ball to the recess in the closed bottom of the IC socket connector; and
attaching the IC socket connector to a circuit board by
coating the solder ball with soldering flux;
placing the IC socket on the circuit board;
melting the solder ball in the recess on the closed bottom of the IC socket connector to get molten solder; and
cooling the molten solder to form a joint between the IC socket connector and the circuit board.

2. The method as claimed in claim 1, wherein the recess is star-shaped.

3. The method as claimed in claim 1, wherein the recess is cross-shaped.

4. The method as claimed in claim 1, wherein the recess is formed by photoetching.
